(19) United States
(12) Patent Application Publication
(10) Pub. No.: US 2008/0136619 A1
(43) Pub. Date: Jun. 12, 2008

(54) SYSTEMS AND METHODS FOR INCORPORATING AN RFID CIRCUIT INTO A SENSOR DEVICE

(75) Inventor: Douglas Moran, Carlsbad, CA (US)

Correspondence Address: BAKER & MCKENZIE LLP;PATENT DEPARTMENT, 2001 ROSS AVENUE, SUITE 2300, DALLAS, TX, 75201, US

(73) Assignee: NEOLOGY, INC., Poway, CA (US)

(21) Appl. No.: 11/952,881

(22) Filed: Dec. 7, 2007

Related U.S. Application Data
(60) Provisional application No. 60/869,089, filed on Dec. 7, 2006.

(51) Int. Cl. G08B 26/00

(52) U.S. Cl. 340/505

(57) ABSTRACT

A RFID sensor comprises a sensor configured to sense a parameter and generate an analog sense signal indicative of the sense parameter, a conversion circuit coupled with the sensor, the conversion circuit configured to convert the analog sense signal to digital sense data, and an RFID transponder coupled with the conversion circuit. The RFID circuit can comprise a memory circuit configured to store the digital sense data and transponder circuitry configured to receive commands through a barrier from a reader and to transmit the stored digital sense data to the reader through the barrier in response to the received commands.

### RELATED APPLICATIONS INFORMATION

This application claims the benefit under 35 U.S.C. 119(e) to U.S. Provisional Patent Application Ser. No. 60/869,089, filed Dec. 7, 2006, and entitled “Semiconductor RFID-Based Through-Barrier Sensors,” which is incorporated herein by reference in its entirety as if set forth in full.

### BACKGROUND

1. Technical Field

The embodiments described herein are related to Radio Frequency Identification (RFID) applications, and specifically to the incorporation of an RFID transponder into a sensor.

2. Related Art

There are many sensor applications in which there is a need to sense various physical parameters in a physical location that is inaccessible without cutting through a barrier. Examples include monitoring pressure in a pipe, water temperature under a boat, wind speed outside of an airplane, etc. Conventional approaches involve creating a hole in the barrier separating the environment to be monitored from the location of the monitor, placing a specially designed sensor in the hole, and then sealing the hole, e.g., to prevent leakage.

Such approaches can, however, create possible safety hazards, increase the chances of a leak occurring, can be costly, and general not preferred.

### SUMMARY

A sensor can be combined with an RFID transponder in order to transmit sensed data through a barrier. This allows convenient sensing of a variety of physical parameters that previously would have required a hole be drilled in the barrier in order to access the sensed data.

In one aspect, a RFID sensor comprises a sensor configured to sense a parameter and generate an analog sense signal indicative of the sense parameter, a conversion circuit coupled with the sensor, the conversion circuit configured to convert the analog sense signal to digital sense data, and an RFID transponder coupled with the conversion circuit. The RFID circuit can comprise a memory circuit configured to store the digital sense data and transponder circuitry configured to receive commands through a barrier from a reader and to transmit the stored digital sense data to the reader through the barrier in response to the received commands.

According to another aspect, a RFID sensor system comprises a RFID reader configured to transmit commands via Radio Frequency (RF) signals, and a RFID sensor. The RFID sensor comprises a sensor configured to sense a parameter and generate an analog sense signal indicative of the sense parameter, a conversion circuit coupled with the sensor, the conversion circuit configured to convert the analog sense signal to digital sense data, and an RFID transponder coupled with the conversion circuit, the RFID circuit comprising a memory circuit configured to store the digital sense data, and transponder circuitry configured to receive the commands through a barrier from the RFID reader and to transmit the stored digital sense data to the reader through the barrier in response to the received commands.

These and other features, aspects, and embodiments are described below in the section entitled “Detailed Description.”

### BRIEF DESCRIPTION OF THE DRAWINGS

Features, aspects, and embodiments are described in conjunction with the attached drawings, in which:

FIG. 1 is a diagram illustrating an example RFID system;

FIG. 2 is a diagram illustrating an example RFID sensor in accordance with one embodiment; and

FIG. 3 is a diagram illustrating an RFID transponder that can be included in the RFID sensor of FIG. 2

### DETAILED DESCRIPTION

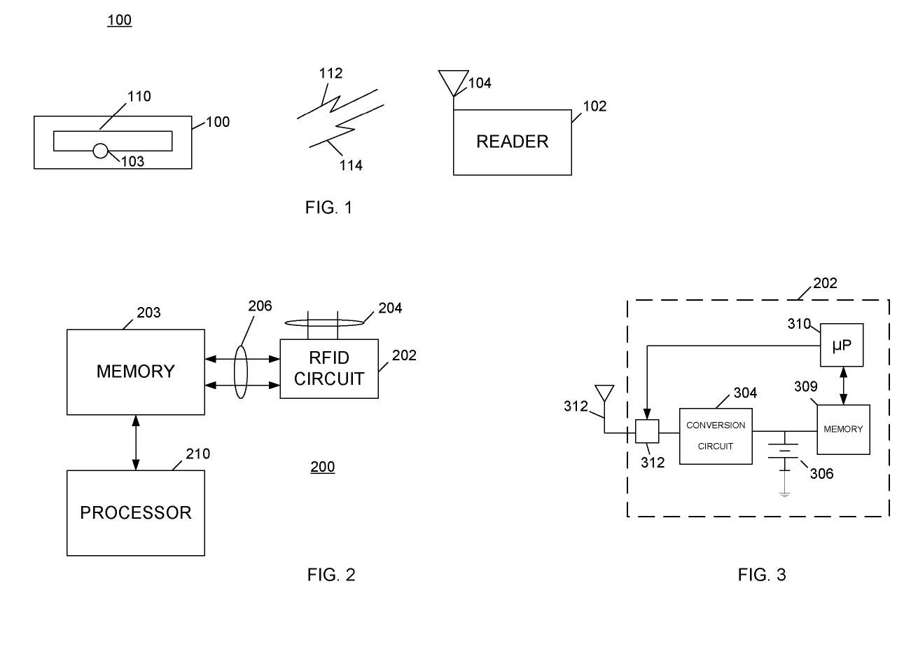

RFID is an automatic identification method, relying on storing and remotely retrieving data using devices called RFID tags or transponders. An RFID tag is an object that can be applied to or incorporated into a product, animal, or person for the purpose of identification using radio waves. Some tags can be read from several meters away and beyond the line of sight of the reader. [0014] An example RFID system 100 is illustrated in FIG. 1. As can be seen, system 100 comprises a RFID reader 102, which can also be referred to as a scanner or interrogator, and an RFID tag 106. Generally, RFID tag 106 will contain at least two parts. One part is an integrated circuit 108 configured to store and process information, modulate and demodulate RF signals 112, and to perform other custom functions. The second part is an antenna 110 for receiving and transmitting the RF signals 112 form and to the RFID reader 102.

RFID tags 106 come in three general varieties: passive, active, or semi-passive (also known as battery-assisted). Passive tags require no internal power source, thus being pure passive devices (they are only active when a reader is nearby to power them), whereas semi-passive and active tags require a power source, usually a small battery.

To communicate, tag 106 respond to queries from reader 102 by generating signals that must not create interference with reader(s) 102, as signals 112 arriving at tag 106, or other tags within the field of signals 112, can be very weak, but must be received and properly decoded. Often, a technology called backscatter modulation is used by tags 106 to generate the signals that are returned to reader 102. Backscatter is the reflection of waves, particles, or signals back to the direction they came from. Thus, tag 106 can receive RF signals 112, modulate data on to them, and then reflect them back to reader 102.

Besides backscattering, load modulation techniques can be used to manipulate the reader's RF field 112. Typically, backscatter is used in the far field, whereas load modulation applies in the near field, within a few wavelengths from the reader.

Passive RFID tags have no internal power supply. Rather, a minute electrical current is induced in antenna 110 by the incoming RF signals 112 that provides just enough power for, e.g., the CMOS integrated circuit 108, and allows tag 108 to transmit a response. Most passive tags signal by backscattering the carrier wave from the reader. This means that antenna 110 has to be designed to both collect power from incoming RF signal 112 and also to transmit the outbound backscatter signal.

Passive tags have practical read distances ranging from about 10 cm (4 in.) (ISO 14443) up to a few meters (Electronic Product Code (EPC) and ISO 18000-6), depending on the chosen radio frequency and antenna design/size. Due to their simplicity in design, passive tags are also suitable for manufacture with a printing process for the antennas. The lack of an onboard power supply means that the device can be quite small, which as explained below allows an RFID circuit to be included in a VLSI design.

Unlike passive RFID tags, active RFID tags have their own internal power source, which is used to power the integrated circuits and broadcast the signal to the reader. Active tags are typically much more reliable (i.e. fewer errors) than passive tags due to the ability for active tags to conduct a “session” with a reader. Active tags, due to their onboard power supply, also transmit at higher power levels than passive tags, allowing them to be more effective in “RF challenged” environments like water (including humans/cattle, which are mostly water), metal (shipping containers, vehicles), or at longer distances, generating strong responses from weak requests (as opposed to passive tags, which work the other way around). In turn, they are generally bigger and more expensive to manufacture, and their potential shelf life is much shorter.

Many active tags today have practical ranges of hundreds of meters, and a battery life of up to 10 years. Active tags typically have much longer range (approximately 500 m/1500 feet) and larger memories than passive tags, as well as the ability to store additional information sent by the transceiver.

Semi-passive tags are similar to active tags in that they have their own power source, but the battery only powers the microchip 108 and does not broadcast a signal. The RF energy 112 is reflected back to reader 102 like a passive tag. An alternative use for the battery is to store energy from reader 102 to emit a response in the future, usually by means of backscattering.

The battery-assisted receive circuitry 108 of semi-passive tag 106 leads to greater sensitivity than passive tags, typically 100 times more. The enhanced sensitivity can be leveraged as increased range (by a factor 10) and/or as enhanced read reliability (by one standard deviation).

The enhanced sensitivity of semi-passive tags place higher demands on reader 102, because an already weak signal is backscattered to the reader. For passive tags, the reader-to-tag link 112 usually fails first. For semi-passive tags, the reverse (tag-to-reader) link 114 usually fails first.

Semi-passive tags have three main advantages 1) Greater sensitivity than passive tags 2) Better battery life than active tags. 3) Can perform active functions (such as temperature logging) under its own power, even when no reader is present.

The antenna 110 used for an RFID tag 106 is affected by the intended application and the frequency of operation. Low-frequency (LF) passive tags are normally inductively coupled, and because the voltage induced is proportional to frequency, many coil turns are needed to produce enough voltage to operate integrated circuit 108.

At 13.56 MHz (High frequency or HF), a planar spiral with 5-7 turns over a credit-card-sized form factor can be used to provide ranges of tens of centimeters. These coils are less costly to produce than LF coils, since they can be made using lithographic techniques rather than by wire winding, but two metal layers and an insulator layer are needed to allow for the crossover connection from the outermost layer to the inside of the spiral where the integrated circuit and resonance capacitor are located.

Ultra-high frequency (UHF) and microwave passive tags are usually radiatively-coupled to the reader antenna and can employ conventional dipole-like antennas. Only one metal layer is required, reducing cost of manufacturing. Dipole antennas, however, are a poor match to the high and slightly capacitive input impedance of a typical integrated circuit 108. Folded dipoles, or short loops acting as inductive matching structures, can be employed to improve power delivery to the IC. Half-wave dipoles (16 cm at 900 MHz) can be too big for many applications; for example, tags embedded in labels must be less than 100 mm (4 inches) in extent. To reduce the length of the antenna, antennas can be bent or meandered, and capacitive tip-loading or bowtie-like broadband structures can also be used. Compact antennas usually have gain less than that of a dipole—that is, less than 2 dBi—and can be regarded as isotropic in the plane perpendicular to their axis.

Dipoles couple to radiation polarized along their axes, so the visibility of a tag with a simple dipole-like antenna is orientation-dependent. Tags with two orthogonal or nearly-orthogonal antennas, often known as dual-dipole tags, are much less dependent on orientation and polarization of the reader antenna, but are larger and more expensive than single-dipole tags.

Patch antennas are used to provide service in close proximity to metal surfaces, but a structure with good bandwidth is 3-6 mm thick, and the need to provide a ground layer and ground connection increases cost relative to simpler single-layer structures.

HF and UHF tag antennas can be fabricated from copper or aluminum. Conductive inks have seen some use in tag antennas but have encountered problems with IC adhesion and environmental stability.

FIG. 2 is a diagram illustrating an example RFID sensor 200 comprising a RFID transponder 202, a conversion circuit 208, and a sensor 210. Sensor 210 can be any kind of sensor configured to sense any type of physical parameter. Some examples can include pressure sensors, temperature sensors, humidity sensors, sensors for atmospherics like ethylene, strain gauges, flow meters, sensors configured to sense depth, sensors configured sense how much of something, e.g., grain is left in a container, e.g., a silo, etc.

As will be understood, such sensors generally sense the physical parameter and generate an analog signal indicative of the sensed data, or measurement. Accordingly, conversion circuit 208 is included and can be coupled with sensor 208 to convert the analog sense signal to digital sense data. For example, conversion circuit 208 can include an analog to digital converter, various filters to, e.g., filter out noise, etc.

It will be understood that some or all of the circuitry included in conversion circuit 208 can be included in sensor 210.

The digital sense data can then be transferred to and stored in RFID transponder 202 via communications interface 206. RFID transponder 202 can then receive commands through antenna port 204 commanding transponder 202 to report the sense data. Importantly, however, sensor 200 can be placed inside a container or on the other side of a barrier from the reader. The transponder, and corresponding antenna, can then be designed to operate at the appropriate frequency and with the appropriate power levels for the data to be read through the barrier or container.

Communication interface 206 can be a serial or parallel communication interface.

As mentioned, a unique identifier programmed into RFID memory can be used to identify a particular sensor 200 so that the data unique to that sensor can be read from memory 208 and associated with sensor 200. If several sensors are present, then this requires some ability to isolate a specific sensor in order to read that sensor. U.S. Pat. No. 5,856,788 to Ron Walter et al., entitled “Method And Apparatus For Radiofrequency Identification of Tags,” which is incorporated herein by reference in its entirety as if set forth in full, describes one example method for isolating a specific RFID device using a bit-by-bit identification process. U.S. Pat. Nos. 6.690,264 7,064,653, both to Dave Dalglish and both entitled “Selective Cloaking Circuit For Use In Radio Frequency Identification And Method Of Cloaking RFID Tags,” both of which are incorporated herein by reference in its entirety as if set forth in full, described methods for cloaking RFID tags that can also be used to isolate and communicate with specific tags.

Thus, a reader can isolate the RFID transponder 202 within a specific sensor 200 using a unique identifier and/or other identifying information and then read the associated sense data. U.S. Pat. No. 7,081,819 to Cortina et al., entitled “System and Method For Providing Secure Identification Solutions,” which is incorporated herein by reference in its entirety as if set forth in full, describes methods for using identifying information stored in RFID memory of an RFID circuit to validate the identity of, e.g., a device with which the RFID circuit is associated.

FIG. 3 is a diagram illustrating an example RFID transponder 202 configured in accordance with one embodiment. In the example if FIG. 3, RFID transponder 202 is a passive RFID transponder. In many embodiments this will be preferable since the reduced foot print of a passive circuit allows for greater integration and smaller devices; however, it will be understood that active or semi-passive circuits can also be used.

Referring to FIG. 3, an RFID circuit 202 can include an impedance circuit 302, a power conversion circuit 304, a storage circuit or device 306, a RFID memory 308 and a processor or controller 310.

The impedance circuit 302 can be configured to match the impedance of an antenna 302 so that circuit 202 can receive RF signals via antenna 302. Power conversion circuit 304 can be configured to convert the energy of signals received via antenna 312 into a DC voltage that can be store in storage device 306. Thus, conversion circuit 304 can comprise some form of rectifying circuit. Storage device 306 can, e.g., be a large capacitor or other circuit capable of storing the voltage generated by conversion circuit 304. Thus, circuit 304 and storage device 306 can comprise a power supply circuit for circuit 202.

RFID memory 308 can be configured to store data, such as a unique identifier as well as data included in signals received via antenna 312 or transferred via interface 206. Processor 310 can be configured to control the operation of circuit 202. For example, processor 310 can be configured to decode information included on signals received via antenna 312. This data can include commands, e.g., requesting processor 310 to store data in memory 308 or read data out of memory 308. Processor 310 can be configured to control impedance circuit 302 in order to transmit data read out of memory 308 back to a reader. For example, processor 310 can be configured alternately to short antenna 312 so as to modulate and reflect an incoming RF signal with data.

While certain embodiments have been described above, it will be understood that the embodiments described are by way of example only. Accordingly, the systems and methods described herein should not be limited based on the described embodiments. Rather, the systems and methods described herein should only be limited in light of the claims that follow when taken in conjunction with the above description and accompanying drawings.

What is claimed is:

1. A Radio Frequency Identification (RFID) sensor, comprising:
a sensor configured to sense a parameter and generate an analog sense signal indicative of the sense parameter;
a conversion circuit coupled with the sensor, the conversion circuit configured to convert the analog sense signal to digital sense data; and
an RFID transponder coupled with the conversion circuit, the RFID circuit comprising:
a memory circuit configured to store the digital sense data; and
transponder circuitry configured to receive commands through a barrier from a reader and to transmit the stored digital sense data to the reader through the barrier in response to the received commands.

2. The RFID sensor of claim 1, wherein the sensor is a temperature sensor, and wherein the parameter is a temperature.

3. The RFID sensor of claim 1, wherein the sensor is a pressure sensor, and wherein the parameter is a pressure.

4. The RFID sensor of claim 1, wherein the sensor is a flow sensor.

5. The RFID sensor of claim 1, wherein the sensor is configured to sense a remaining capacity.

6. The RFID sensor of claim 1, wherein the memory circuit is further configured to store a unique identifier, and wherein the transponder circuitry is further configured to transmit the unique identifier through the barrier to the reader in response to the received commands.

7. A RFID sensor system, comprising:
a RFID reader configured to transmit commands via Radio Frequency (RF) signals; and
a RFID sensor, comprising:
a sensor configured to sense a parameter and generate an analog sense signal indicative of the sense parameter,
a conversion circuit coupled with the sensor, the conversion circuit configured to convert the analog sense signal to digital sense data, and
an RFID transponder coupled with the conversion circuit, the RFID circuit comprising a memory circuit configured to store the digital sense data, and transponder circuitry configured to receive the commands through a barrier from the RFID reader and to transmit the stored digital sense data to the reader through the barrier in response to the received commands.

8. The RFID sensor system of claim 7, wherein the sensor is a temperature sensor, and wherein the parameter is a temperature.

9. The RFID sensor system of claim 7, wherein the sensor is a pressure sensor, and wherein the parameter is a pressure.

10. The RFID sensor system of claim 7, wherein the sensor is a flow sensor.

11. The RFID sensor system of claim 7, wherein the sensor is configured to sense a remaining capacity.

12. The RFID sensor system of claim 7, wherein the memory circuit is configured to store a unique identifier, and wherein the RFID reader is configured to read the unique identifier, verify the identity of the integrated circuit based on the unique identifier, and then request the stored digital sense data via the commands.

13. RFID sensor system of claim 12, wherein the RFID reader is configured to isolate the RFID sensor from among a plurality of RFID sensors using the unique identifier, before requesting the digital sense data.

14. RFID sensor system of claim 7, wherein the RFID transponder further comprises a storage circuit configured to store energy included in the RF signals, and a power supply circuit coupled with the storage circuit, the power supply circuit configured to use the stored energy to supply power to the RFID transponder.

15. RFID sensor system of claim 14, further comprising an antenna coupled with the RFID transponder, and wherein the storage circuit comprises a rectifier configured to rectify a signal received from the antenna and a large capacitor, and wherein the rectified signal charges the capacitor.

16. RFID sensor system of claim 14, wherein the RFID transponder is further configured to supply power to the sensor using the stored energy in the power supply circuit.

17. RFID sensor system of claim 7, further comprising a communication interface coupling the conversion circuit with the RFID transponder, and wherein the RFID transponder uses the communication interface to receive the digital sense data from the conversion circuit.

18. T RFID sensor system of claim 17, wherein the communication interface is a serial interface.
